(19) United States
(12) Patent Application Publication
(10) Pub. No.: US 2007/0070959 A1
(43) Pub. Date: Mar. 29, 2007

(54) Infrastructure mesh networks

(76) Inventors: Kevin C. Almeroth, Santa Barbara, CA (US); Elizabeth M. Belding, Goleta, CA (US); Milind M. Buddhikot, Manalapan, NJ (US); Girish Chandranmenon, Edison, NJ (US); Scott C. Miller, Freehold, NJ (US); Krishna N. Ramchandran, Goleta, CA (US)

Correspondence Address: HARNESS, DICKEY & PIERCE, P.L.C., P.O. BOX 8910, RESTON, VA, 20195, US

(21) Appl. No.: 11/233,132

(22) Filed: Sep. 23, 2005

(51) Int. Cl. H04Q 7/24; H04L 12/56

(52) U.S. Cl. 370/338; 370/401

(57) ABSTRACT

The mesh network, according to at least one embodiment, includes a relay associated with each access point in the mesh network. Each relay is configured to support access interfaces and relay interfaces. The access interfaces are configured to communicate with mobile nodes, and the relay interfaces are configured to communicate with other relays. The mesh network further includes at least one gateway associated with the relays. The gateway is configured for connection to an external network. The gateway is also directly associated with at least one of the relays such that the gateway communicates with the relays via the directly associated relay. The gateway provides for communication between the external network and the relays.

### BACKGROUND OF THE INVENTION

In the world of ubiquitous mobile wireless networks that is taking shape, wireless mesh networks are emerging as a significant new technology. Their promise of rapid deployabilty and reconfigurability makes them suitable for important applications such as disaster recovery, homeland security, transient networks in convention centers, hard-to-wire buildings such as museums, unfriendly terrains, and rural areas with high costs of network deployment. They can provide large coverage area, reduce “dead-zones” in wireless coverage, lower costs of backhaul connections for base-stations, and improve aggregate 3G, 802.11 cell throughput and help reduce end-user battery life.

Generally, there are two kinds of mesh networks: (a) client-mesh networks and (b) infrastructure mesh networks. In client-mesh networks, end-user devices (such as PDAs, laptops) participate in packet forwarding. These networks are infrastructure less in the sense that, operation of the client-mesh is not managed and monitored by a service provider. They are useful for opportunistic or predictable store-and-forward message transport. Alternately, when used only for packet forwarding for multi-radio clients (for example, with 3G and 802.11 interfaces), they improve coverage and data rates for wide area cellular service. In infrastructure-mesh networks, the end-devices do not participate in the packet relay and the multi-radio relay nodes are part of the network infrastructure.

### SUMMARY OF THE INVENTION

Embodiments of the present invention provide a self-configuring, secure infrastructure mesh network architecture formed using multi-radio network nodes. A subset of radio interfaces on the relay nodes are used for providing network access to end-user devices whereas other radio interface are used for relaying packets to a nearest internet gateway. The embodiments provide structure and methodology for (1) auto-configuration of the nodes and relay infrastructure, (2) single and multipath routing in the relay infrastructure using routing metrics, (3) load balancing in the relay infrastructure to make best use of the channel capacity, interfaces of mesh network, and/or (4) mobility management.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates an infrastructure mesh network architecture according to one embodiment of the present invention;

FIG. 2 illustrates an example of an AODV-ST spanning tree for a sample network of seven relays and two gateways;

FIG. 3 illustrates a cases where an upstream relay may receive a duplicate RREQ from the same downstream relay if the duplicate RREQ represents a better reverse path;

FIG. 4 illustrates the infrastructure mesh network according to an embodiment of the present invention that supports Mobile-IP (MIP) based mobility management;

FIG. 5 illustrates the infrastructure mesh network according to an embodiment of the present invention that supports MobileNAT based mobility management; and

FIG. 6 illustrates the infrastructure mesh network according to an embodiment of the present invention that supports a simple DHCP based mobility management.

### DETAILED DESCRIPTION OF EXAMPLE EMBODIMENTS

With respect to the embodiments of the present invention described in detail below, first an infrastructure mesh network architecture will be described followed by a description of an secure auto-configuration scheme. Next, design of the routing architecture and packet forwarding components of the infrastructure mesh network architecture will be described. Then a load balancing solution and mobility management solution will be described.

I. Infrastructure Mesh Network Architecture

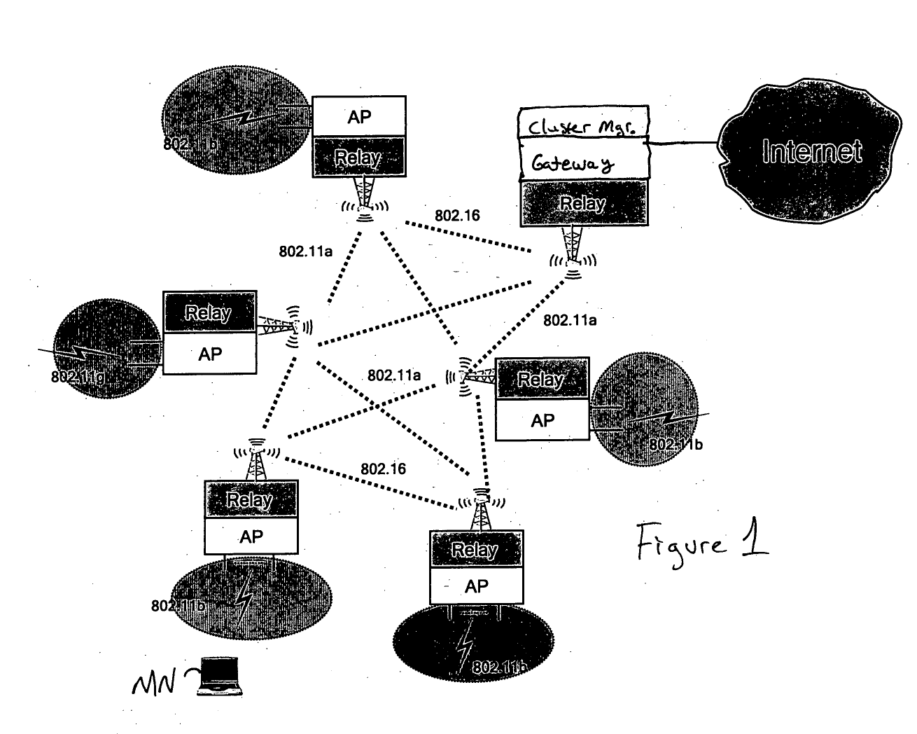

FIG. 1 illustrates an infrastructure mesh network architecture according to one embodiment of the present invention. The architecture illustrated in FIG. 1 includes two new network elements: the relay and the gateway nodes. The relay nodes are multi-radio systems that support two kinds of wireless network interfaces: access and relay. The gateway nodes support: relay and Internet back-haul (up-link) interfaces. The end-user mobile nodes (MNs) access the network using the access interfaces. An end-user mobile node MN may be a wireless equipped PDA, computer, cell phone, etc. The relay interfaces are used to construct a self-configuring, secure, managed, power adaptive packet forwarding backbone between the relay and gateway nodes. The access links may be based on, for example, 3G or 802.11 standards, whereas the relay links may be based on, for example, 802.16 or 802.11. It will be understood that these example are non-limiting.

The gateways are connected to the Internet via, for example, wired (Ethernet) or wireless (1xRTr, EV-DO, 802.16) up-links. The placement of relays and gateway nodes depends on the deployment scenario. For example, in the case of a municipal metro area network aimed at providing broadband access to end-users, relays may be mounted on poles and the gateway nodes may be located in data centers in one of the downtown buildings. The in-building mesh networks such as enterprise buildings, convention centers, museums may follow similar structured placement. In both these scenarios, relay nodes will be stationary. On the other hand, in applications where transient networks are created such as for disaster recovery and outdoor events, the relays may be placed arbitrarily and may be quasi-stationary. In some cases such as defense applications, where soldiers in vehicles use relays to communicate to their command-and-control via a remote gateway node, relay mobility may be significant.

A cluster manager entity, optionally co-located with the gateways as shown in FIG. 1, implements management and monitoring functions such as power level and frequency assignment for access and relay links, load-balancing in the relay cluster, and mobility and authentication support.

Next, in the context of an architecture as shown in FIG. 1 with an 802.11 based relay network, the following will be discussed and described in detail: (1) robust, secure auto-configuration and associated protocol, (2) packet routing and forwarding in the relay cluster that adapts to failures and network conditions such as load and interference and optimizes common-case traffic, (3) load balancing in the relay infrastructure, and (4) seamless end-user mobility across the relay nodes.

II. Secure Auto-Configuration

The architecture according to an embodiment of the present invention uses a secure registration and auto-configuration protocol to register nodes with the cluster manager. This protocol operates at the IP layer.

Each relay runs a auto-configuration agent (not shown) initialized at the boot time. This agent uses one or more of the relay interfaces to listen to Extended Service Set Identifier (ESSID) broadcasts for ad hoc networks operating in its area. For each ESSID, the agent first joins the ad hoc network using the Basic Service Set Identifier (BSSID) broadcast. It then picks an IP address from the zero-configuration address space 169.254.*.* and joins the IP based relay infrastructure. The 16 bits of the selected address can be computed using a truncated hash of the medium access control (MAC) address and time-of-the-day string. Since the hash is likely to be unique, the probability of the event of multiple nodes booting simultaneously and picking the same address is significantly low. The relay node then listens for the gateway advertisements, periodically received and rebroadcast by the relays already part of the architecture. These advertisements contain gateway capability information such as Internet back-haul link speeds, relay capacity, best path available through the relay that rebroadcast the gateway advertisements, etc. The auto-configuration agent begins a configuration session, in which the determined ESSID is used to identify the relay, with one or more gateways selected based on certain criteria, for example closest gateway—gateway which can be reached by a shortest hop-count path or based on capabilities such as capacity—least loaded gateway or high capacity gateway.

The auto-configuration protocol supports an optional authentication phase using an authentication scheme and backend AAA authentication. For example, the agent performs mutual authentication to the gateway using security credentials such as digital certificates or a symmetric key stored in the relay in tamperproof hardware. The authentication protocol may resemble IEEE 802.11i with the difference that Extensible Authentication Protocol (EAP) packets are IP-encapsulated instead of Ethernet encapsulated. Any of the EAP schemes that support mutual authentication and dynamic session security key derivation such as EAP-TLS, EAP-SIM, EAP-AKA may be employed. Using the derived session keys packet flow between the relay and gateway may be encrypted. If each relay node is authenticated to the gateway, a common dynamic group key may be securely distributed and used to protect routing protocol messages. Clearly, to achieve this, the relay network may operate two ESSIDs, one (e.g., Join-Mesh) for traffic during the authenticate-and-join phase and the other (e.g., Authenticated-Mesh) for the post authentication phase. 019 The relay agent of the relay conveys its capabilities such as number and type of radio interfaces and its observed environment such as visible neighbors in different frequency ranges, observed interference etc. that may be useful to the gateway for frequency assignment. The gateway conveys configuration parameters to the relay such as ESSID for access, frequencies to use on relay and access interfaces, power levels to use, mobility method to use, addressing schemes, and any path-specific information (e.g., packet loss rate, bandwidth, hop length, delay, etc.). After the configuration session is complete, the zero-configuration address is relinquished but the security parameters for the session may be preserved for future reconfigurations.

III. Routing Architecture

Various design options are detailed in the following: The relay network could employ layer-2 Ethernet bridging and its associated 802.3d spanning tree based forwarding. In this case, the access cloud of the relays appears as a big layer-2 network at the gateway nodes. This has the advantage that no access and relay subnet management is required and layer-3 mobility is rather easy to support. However, such visualization comes with the cost of transporting the entire layer-2 packet originating in the access networks to the gateway nodes and a complex virtualizing of the Ethernet layer. Also, naive use of protocols such as Dynamic Host Configuration Protocol (DHCP), Address Resolution Protocol (ARP), Reverse Address Resolution Protocol (RARP) that employ layer-2 broadcast may result in bandwidth wastage in the relays.

A layer 3 solution does not suffer from these drawbacks and also, operates effectively across the different physical layer technologies that may be used in a heterogeneous mesh network deployment. The use of a layer 3 solution is especially beneficial with the rapid innovation in physical layer technologies and the increasing availability of them in the market. Accordingly, while layer 2 routing may be performed in this embodiment, layer 3 routing is adopted.

Leveraging existing wireline routing protocols such as Open Shortest Path First (OSPF) or Routing Information Protocol (RIP) for routing within the mesh network, if adopted, would take advantage of extensively tested and optimized wireline protocols for routing within the mesh. Furthermore, the task of network management would be greatly simplified because of the easy availability of tools that manage and monitor wireline protocols. However, wireline routing protocols oftentimes result in relays exchanging a high volume of periodic control messages, which can be a significant traffic overhead in bandwidth constrained wireless mesh networks. Furthermore, wireline routing protocols typically assume that the relays are static. This assumption fails to hold in a wireless mesh network where relays can be mobile. Wireline protocols may be used in the present invention, but may be inefficient in handling network mobility.

Optimiizing for common-case traffic: In most deployment scenarios of mesh networks, a significant portion of traffic in the relay network is due to end-user access to services such as web servers, virtual private network (VPN) gateways, and database and file servers in the wired infrastructure such as the Internet or enterprise networks. The data traffic, such as voice-over-IP (VOIP) and multimedia flows, between end devices (e.g., mobile nodes) in access clouds of two different relays will be a small fraction of the total traffic. As such, optimzing routing to efficiently support forwarding of the common case (e.g., the gateway destined traffic) can improve performance of the relay infrastructure.

Using existing ad hoc routing protocols: Existing ad hoc routing solutions, such as Ad Hoc On-Demand Distance Vector (AODV), Dynamic Source Routing (DSR), and Optimized Link State Routing (OLSR) for routing within the mesh may also be used. These protocols inherently support network mobility and are designed to be low-overhead in their operation. These features makes them attractive for use in wireless mesh networks. OLSR is a link state routing protocol, analogous to Open Shortest Path First (OSPF) and relies on knowledge of complete topology information at the nodes. It is quite efficient if the traffic is distributed equally between any two pairs of nodes, which is in contrast to the common case traffic argument above. AODV is a simple, low-overhead, reactive routing protocol that is standardized in IETF and has public domain robust implementations. Accordingly, while not limited to AODV, this embodiment uses AODV as a base routing protocol. Also, one can conceivably design a hybrid protocol that reacts to traffic patterns and switches from an AODV based protocol to a OLSR-based protocol in the event traffic distribution becomes more uniform.

A. Design of AODV-ST

The use of AODV “as-is” may lead to a poor mesh routing solution due to following operational deficiencies:
1. AODV lacks support for high throughput routing metrics: AODV is designed to support the shortest hop count metric. This metric favors long, low-bandwidth links over short, high bandwidth links. Furthermore, AODV computes the metric using a broadcast discovery mechanism. Broadcast packets are typically sent at the lowest data rate and hence the propagation characteristics of higher data rate unicast packets cannot be accurately predicted using broadcast packets. Because of these reasons, AODV may select routes with poor end-to-end throughput.
2. AODV lacks an efficient route maintenance technique: A route discovered with AODV may no longer be the optimal route further along in time. This situation can arise because of network congestion or the fluctuating characteristics of wireless links. AODV lacks a provision to re-discover the new optimal route. Several known-proposed techniques overcome this drawback by discovering multiple routes to a destination. These routes are then individually monitored for their path characteristics. In a large-scale wireless mesh network, the number of paths monitored by the relays can potentially be very large and can result in high control-traffic overhead.
3. AODV route discovery latency is high: AODV is a reactive routing protocol. This means that AODV does not discover a route until a flow is initiated. This route discovery latency can be high in large-scale mesh networks.
4. Large routing table sizes: AODV is designed for classic ad hoc networks where traffic flows are between nodes or node clusters rather than between nodes and Internet hosts. Simplistic reuse of AODV implementations result in routing table entries at relay nodes for all Internet hosts accessed by end devices in the access clouds. As such the routing tables can become unnecessarily large. AODV may be augmented with appropriate tunneling mechanisms to optimize routing table size for common case traffic.
In view of the above, and while AODV may be used, this embodiment uses an enhanced AODV-Spanning Tree (AODV-ST) protocol, which may eliminate at least some of the above limitations as follows: First, this protocol supports high throughput metrics, such as Expected Transmission Count (ETX) and Expected Transmission Time (ETr). Second, it proactively maintains spanning trees whose roots are the gateways in the mesh network to significantly reduce route discovery latency and achieve lightweight, soft state route maintenance. Last, this protocol employs IP-in-IP tunnels to reduce the routing table at relays to a sum total of the number of relays and access subnets.

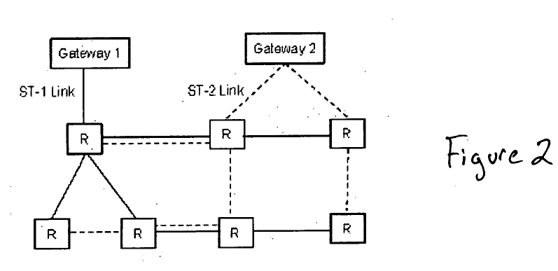

FIG. 2 illustrates an example of an AODV-ST spanning tree for a sample network of seven relays and two gateways. Each relay in the network lies on two spanning trees ST-1 (shown by solid lines) and ST-2 (shown by dashed lines). The gateways initiate the creation of the spanning trees by emanating periodic control messages that are selectively broadcasted in the network. Each spanning tree is created such that a relay node on a tree lies on the optimal path to the gateway corresponding to that tree. The route maintenance overhead is kept to a minimum because the paths to the relays on the spanning trees are proactively maintained. Furthermore, the route discovery latency is eliminated as each relay in the network is aware of an optimal path to its default gateway. A relay chooses the gateway with which it can achieve the highest capacity (as determined by the routing metric as described in more detail below) as its default gateway. For relay-to-relay communication, AODV-ST relies on the reactive route discovery strategy utilized in AODV. Conceptually, AODV-ST is a hybrid routing protocol: it uses a proactive strategy to discover routes between commonly used end-points (relay-to-gateway) and uses a reactive strategy for routes between less-commonly used end-points (relay-to-relay).

In the following, a brief overview of AODV is provided and then the specifics of AODV-ST protocol operation are described.

B. AODV Overview

AODV is an on-demand ad hoc routing protocol. For neighbor detection, AODV can use either well-known broadcast HELLOs or well-known link layer feedback. Route discovery is based on a <route request, route reply> cycle. Route discovery begins with a broadcast Route Request (RREQ) message containing the destination address for the requested route and a RREQ sequence number that guarantees loop-free operation. As the RREQ is propagated throughout the network, each intermediate node creates a reverse route entry towards the originator (source) of the RREQ. An intermediate node forwards only the first RREQ it receives from the originator. If the destination-only flag is set in the RREQ message, only the destination is allowed to issue a Route Reply (RREP). If the destination-only flag is not set in the RREQ, an intermediate node is allowed to issue an RREP provided it has an active route towards the destination. The RREP message is unicast towards the source along the reverse route setup during RREQ propagation. As the RREP is propagated, intermediate nodes on the reverse route create a forward route entry for the destination node in their respective route tables. When an active route breaks, the node in the route that detects the break has the option of doing a local repair by finding another route towards the destination, or sending a Route Error (RERR) message towards the source to notify it of the break.

C. The AODV-ST Routing Protocol

In AODV-ST, the gateways periodically broadcast RREQ messages to initiate the creation of spanning trees. Before a RREQ is broadcast, a gateway sets the destination-only flag in the RREQ and sets the RREQ destination address to the network-wide broadcast address. These settings differentiate normal route discovery RREQs from the RREQs for spanning tree creation. A RREQ also contains a metric field which is set to zero by the gateway. When an intermediate relay receives an RREQ, it checks if the RREQ is a gateway-initiated RREQ. If the condition is satisfied, it creates a reverse route to the gateway provided the RREQ is received on the best known path to the gateway. The relay can make this determination because of the metric field contained in the RREQ. This field is updated by each intermediate relay to represent the characteristics of the path it has traversed. The specific handling of the field at each relay is dependent on the path metric being used. To simplify the explanation, metric handling will be described in the next subsection. Once a relay creates a reverse route entry for the gateway, it sends a gratuitous RREP back to that gateway. This gratuitous RREP also has a metric field that is set to zero initially. The field is updated at every intermediate relay on the path to the gateway. When an intermediate relay receives the gratuitous RREP, it creates a forward route to the originating relay, and updates the path metric to the originating relay with the metric value contained in the gratuitous RREP.

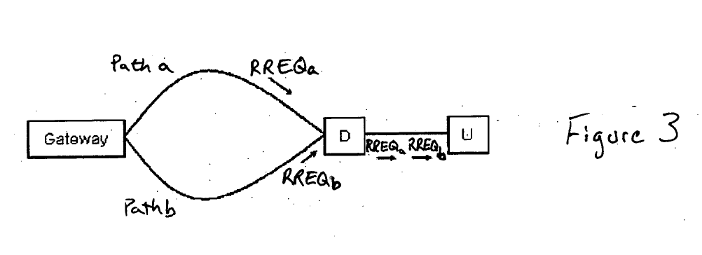

A relay re-broadcasts a gateway initiated RREQ only if the path traversed by the RREQ is the best known path to the relay. Note that an intermediate relay does not wait until it receives all RREQs before picking the best one to rebroadcast. This reduces the route discovery latency. This means that an upstream relay may receive a duplicate RREQ from the same downstream relay if the duplicate RREQ represents a better reverse path. This mode of operation is illustrated in FIG. 3. Relay D in FIG. 3 receives two RREQs from the gateway. The two RREQs traverse two different paths a and b, where a is better than b. Assume that the RREQa over path a, is slightly delayed with respect to RREQb over path b. When D receives RREQb, D rebroadcasts it as it arrived on the first path known to D. However, when the delayed RREQa, is received, D rebroadcasts it because it arrived on the better path. Relay U therefore receives two duplicate RREQs from D.

As the RREQ is broadcasted hop-by-hop throughout the mesh network, the spanning tree is implicitly formed through the creation of reverse routes to the gateway at the relays. The time interval between successive gateway-initiated RREQs is set to ten seconds in this embodiment. This time interval was empirically determined to be a good setting. Each relay, on receiving the successive RREQs, updates its reverse routes based on the metric field contained in the RREQs.

For relay-to-relay communication, a relay node initiates a RREQ with the destination flag set and the destination address set to the address of the node to be reached. The destination flag is set because the most up-to-date path information is required at the source during path selection. The handling of the RREQs at the intermediate nodes is similar to the procedure described above.

D. Routing Metric Support in AODV-ST

A routing metric used with AODV-ST according to this embodiment satisfies two requirements: First, the metric increases in value with increasing hop count. This prevents loop-free path selection. Second, the metric is a bi-directional metric. Namely, the metric gives equal weight to a path's performance in the forward and reverse directions. This is helpful for two reasons. First, TCP flows are bidirectional in nature. Therefore, both directions of a path are considered during route selection. Second, AODV-ST creates a reverse route to a gateway upon receiving a RREQ that traverses in the forward direction from the gateway to the relays. Therefore, the metric represents a path's performance in both directions, otherwise AODV-ST may select uni-directional paths.

In this embodiment of AODV-ST, the Expected Transmission Time (EIT) metric is supported to judge the best path; however, as discussed above, ETX or other such throughput metrics may be used. The ETm metric is a measure of the expected time needed to successfully transmit a packet of a fixed length, s, on a link. Use of this metric yields high throughput paths because a path with the least delay will be selected. ETI is given as (etx*s/b) where etx is the expected number of transmissions necessary to send a packet on the link; s is the size of the packet (set, for example, to 1024 bytes in this embodiment); and b is the bandwidth of the link. etx is computed by issuing periodic broadcast probe messages (sent every second, for example, in this embodiment)) in the forward and reverse directions and by measuring the corresponding forward delivery ratio (df) and the reverse delivery ratio (dr) for a predetermined time interval. This time interval may be set to, for example, ten seconds. The etx for the link is then given as etx=1/(df*dr). The link bandwidth, b, is determined using feedback from the radio driver. For example, the well-known hostap driver may be modified to support the feedback of the link data rate every second. The driver computes per-second link data rates by averaging the data rates of packets that traverse a link in the one second intervals. Where a driver does not provide rate feedback, packet-pair probing may be relied on to estimate the bandwidth. To implement this technique in this embodiment, a pair of packets, one small (134 bytes) and the other large (1200 bytes), are sent back-to-back every minute for ten minutes in both directions of the link. As soon as the smaller size packet is received, a timer is started to measure the delay incurred in receiving the larger packet. A minimum of ten delay samples, for example, has been chosen to estimate the link bandwidth. The link bandwidth then is simply the ratio of packet size and minimum delay. The minimum delay sample may be used to reduce any adverse impact queuing delays have on the transmission of the packet pairs.

Another possible metric to use is the Weighted Cumulative Expected Transmission Time (WCETT) metric. WCETT requires knowledge about each link in the path, such as the link's delay and its assigned frequency. This requirement may be satisfied by using a link-state routing protocol such as OLSR or OSPF. On the other hand, AODV-ST is a distance-vector routing protocol in which link-level information is not disseminated by design. This may complicate the support of WCETT in AODV-ST.

IV. Load Balancing

A. Load Balancing Defined

Load balancing is a desirable feature to have in a wireless mesh network. It reduces congestion in the network, increases network throughput, and prevents service disruption in case of failure. Load balancing in wireless mesh networks may be defined in the following two ways:
Path load balancing: Path load balancing can improve network performance and reliability by distributing traffic among a set of diverse paths. There are proposals to achieve path load balancing in wireline networks and multi-hop wireless networks. It has been shown that path load balancing provides negligible performance improvement in wireless multi-hop networks because of route coupling of candidate paths between common endpoints. Route coupling is the result of the geographic proximity of the candidate paths. This can lead to self-interference between those paths and can therefore adversely impact performance.
Gateway load balancing: In this interpretation of load balancing, traffic is distributed among a set of gateways in the wireless mesh network, (e.g., one of several gateways is chosen as the egress point for flows originating from the network). The performance improvement with gateway load balancing may be greater than with path load balancing because route coupling of paths to different gateways from an endpoint in the mesh is expected to be less in a well-planned network deployment. Accordingly, while not limited to using gateway load balancing, this embodiment of the architecture supports gateway load balancing.

B. Gateway Load Balancing Protocol

An access relay (relay that is also an access point) lies on the spanning trees corresponding to the gateways in the network as described in Section III. The access relay selects one of the discovered gateways as its default gateway. The default gateway is the one with which the relay may achieve the highest capacity (as determined by the routing metric). The access relay typically uses the default gateway as the egress point for the flows initiated by it. Each access relay in the network also monitors the quality of the best path to each of its gateways. The best path is simply the path on the spanning tree computed for that gateway. As described in Section III, the paths on a spanning tree created for a gateway represent the optimum paths (in terms of the routing metric) from the gateway to the relays on that tree. The path quality may be monitored, for example, using any well-known round trip time (RTT) probing tool. The tool reports RTT values for each of the gateways in the network. The gateway with the least-delay is designated as the least-loaded gateway. In an unloaded wireless mesh network, the default gateway will typically be the least-loaded gateway. When an access relay detects that its least-loaded gateway and its default gateway are different, it infers that there is congestion in the network on the path leading to its default gateway. In this case, the new flows initiated by the relay utilize the least-loaded gateway as their egress point.

In this embodiment, the relay does not migrate any of its existing flows to the least-loaded gateway. This may be required where network address translation (NAT) is employed at the gateways; otherwise, flow migration may result in the disruption of flows unless the per-flow state at the network address translators (NATs) is also migrated. Also, the requirement can be relaxed if the mesh relays are assigned globally routable addresses in which case network address translation would not be required at the egress points.

V. Mobility Support

There are several mobility mechanisms that may be employed in the architectures of the present invention. Non-limiting examples include mobile IP, a mobile form of NAT, and a simple DHCP based mobility.

A. Mobile IP

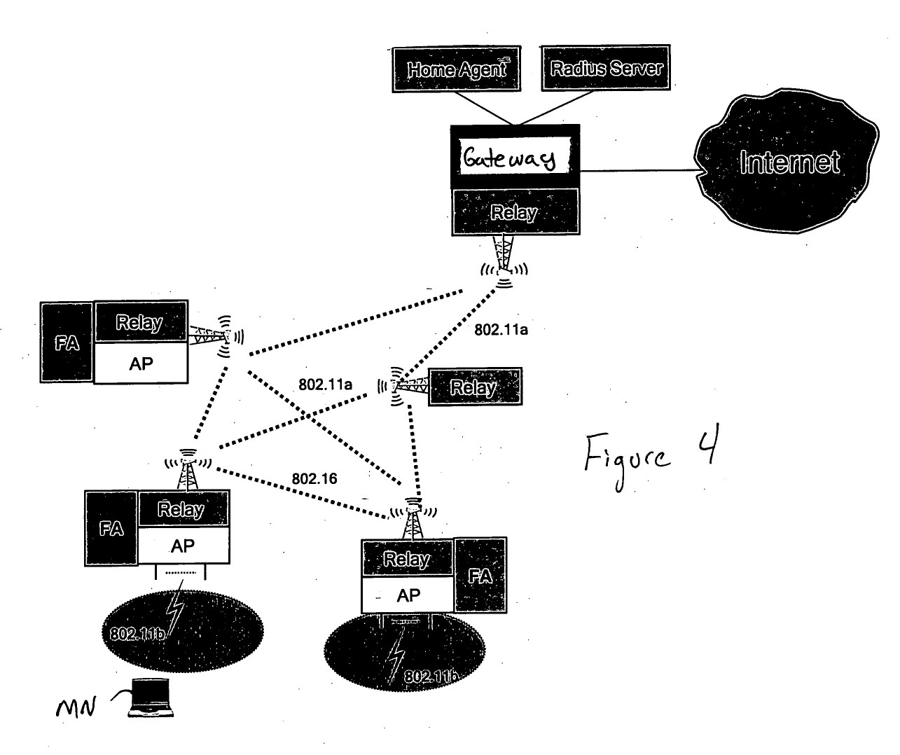

Mobile-IP (MIP) has been standardized for Internet scale mobility for end-hosts. The same solution may be employed for domain mobility in the context of mesh networks as shown in FIG. 4. In this case, the MIP Home Agent (HA) is co-located with the gateway nodes whereas the MIP Foreign Agent (FA) functionality is instantiated in the access network in each relay element. The end-user mobile node MN is assigned a home IP address (HADDR), statically during configuration, or using dynamic home address assignment. The mobile node MN detects a change in layer-2 association by monitoring the MAC address of the access points in the relay. In the event of an access point switch, the mobile IP client in the mobile node MN initiates a mobile IP registration (solicitation, advertisement, and registration) with the FA on the new access point. Once the registration is complete, the HA at the gateway node will tunnel all traffic for the mobile to the new FA.

In the event, the HA uses only private addresses, the MIP is used as a domain level micro-mobility method. If the HA employs public addresses, then the mobile node MN is reachable from the public Internet.

B. MobileNAT Based Mobility

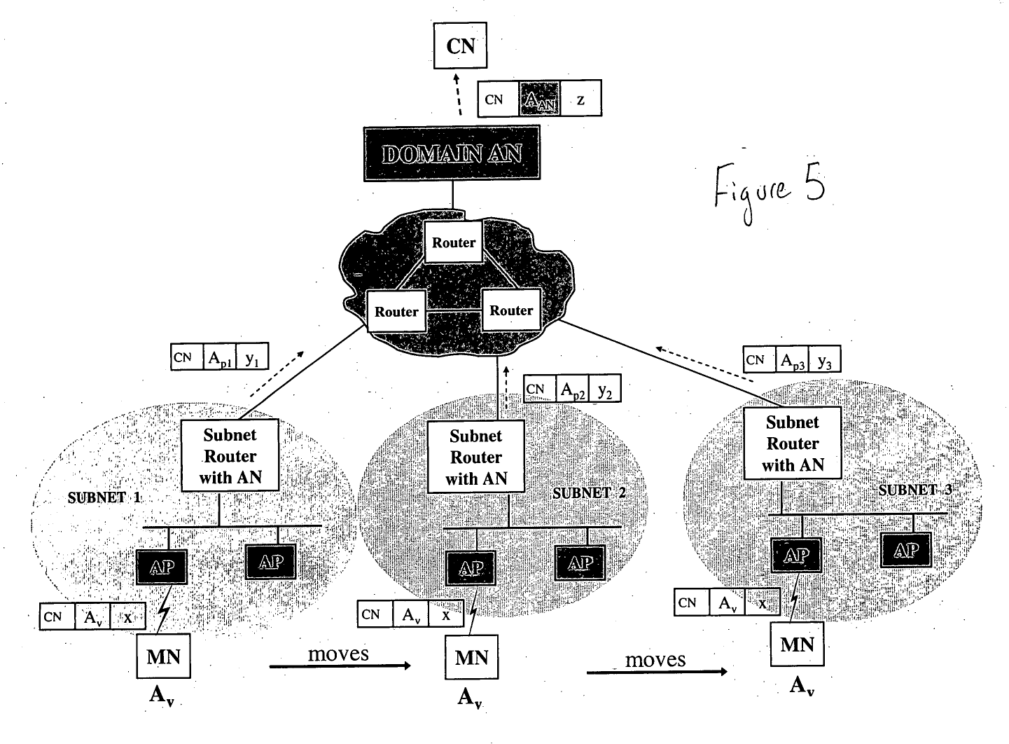

MobileNAT is a new technique that uses Network Address Translation (NAT) operations and specialized mobility agents in the signaling path to achieve transparent mobility. As shown in FIG. 5, the gateway node here serves as the Anchor Node (AN), which NATs all end-user traffic to external Internet hosts. From the perspective of the external hosts traffic is anchored on the public IP addresses of the gateway (AN) node. The mobile node MN acquires a fixed IP address A, when it first boots and associates with one of the relays. MobileNAT allows the mobile node MN to hold this address as it roams across access networks of relays. To understand this, consider a TCP flow to an external correspondent node (CN) where SA stands for source address, DA stands for destination address, and SP stands for source port. The relay node NATs the traffic with (SA=Av, DA=CN, SP=x) to (SA=Aₚ₁, DA=CN, SP=y₁) using a rule (Aₚ₁ [symbol] Av, x [symbol] y1) and tunnels to AN using (SA=Aₚ₁, DA=AN) tunnel header. The AN NATs this further to (SA=AN, DA=CN, SP=z) with a rule (Aₚ₁ [symbol] AN, y₁ [symbol] z). When the mobile node MN moves to a new relay node with external IP address Aₚ₂, the mapping at AN is changed (Aₚ₂ [symbol] AN, y₂ [symbol] z) and a new mapping (Aₚ₁ [symbol] Av, x [symbol] y₂) at the relay. The change of mapping rules at the relay and AN are signaling path operations, and are carried out by mobility agent software running at the AN and relays. This software also detects the arrival of new “visiting” nodes at the relay by performing IP-level packet filtering with missing NAT rules. Note that the scheme has several advantages: (1) no client side software is required; (2) the scheme is agnostic to the routing protocol in the relay network; (3) the access networks of relays can be managed as separate subnets or as part of a large subnet; (4) addresses visible in the relay network are that of the externally visible Aₚ₁ addresses of the relays. None of the Av addresses of the mobile nodes MNs are visible, keeping the routing tables quite compact.

C. Simple DHCP Based Mobility

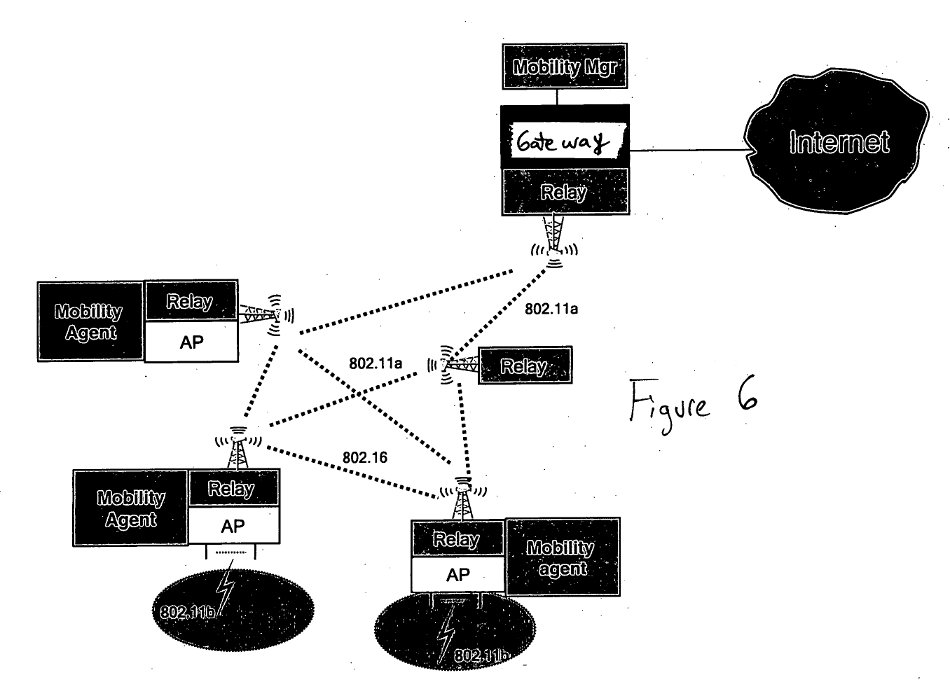

FIG. 6 illustrates a simpler mobility scheme which relies on DHCP, AODV and monitoring of layer-2 events in the access networks of relay nodes. Much like the MobileNAT scheme above, it allows a client to acquire a dynamic IP address and maintain that address as it moves across multiple relays. Also, it relies on a mobility manager (MM) at the gateway nodes and a mobility agent (MA) on the relays. The MAs in the relays monitor changes in the layer-2 802.11 associations to detect new visiting mobile endpoints and propagate routes for the corresponding IP address in the AODV based relay network. If the MN has an address x, for the traffic destined to the CN, the packets (SA=x, DA=CN) are tunneled to the gateway with a tunnel header (SA=x, DA=GW). The reverse traffic to x does not need to be tunneled and carries (SA=CN, DA=x). Whenever, AODV route requests are launched for x, the most recent relay with x, responds with a router reply. The artifact of this is that the forwarding entry for address x appears in AODV routing tables at the relay nodes. The MAs in different relays in the mesh can allow proactive updates amongst themselves on detection or loss of mobile nodes MNs to help make AODV state update fast. This can help handoff performance and also, help track mobility of the end-user across multiple relays in the network. One issue that affects the performance of this technique is how well host operating system on the mobile node MN reacts to switching between two access points in the mesh network. If the ESSID for access clouds on all relays is identical, the host OS only requires completion of layer-2 association with the new AP; it does not require an additional DHCP request and response to configure its interface IP address. As a result, the handoff is much faster. On the other hand, if each relay access ESSID is different, in the absence of any out-of-band or pre-configured information, the OS may assume the worst and restart DHCP transactions. Even though the same IP address may be returned, if the protocol stack associated with the interface is brought down during this process to account for the worst case of obtaining a different IP address, the flows are broken. Therefore, in this embodiment, the ESSID is kept the same for the access points in one mesh network. Another alternative is to use a mobile IP client, which masks such disconnects by design.

The wireless mesh network according to embodiments of the present invention provides a promising new technology for the rapid deployment of wireless networks for applications such as search and rescue, home land security, and metro-scale broadband connectivity.

The invention being thus described, it will be obvious that the same may be varied in many ways. Such variations are not to be regarded as a departure from the invention, and all such modifications are intended to be included within the scope of the invention.

We claim:

1. A mesh network, comprising:
a relay associated with each access point in the mesh network, each relay configured to support access interfaces and relay interfaces, the access interfaces configured to communicate with mobile nodes, the relay interfaces configured to communicate with other relays, and
at least one gateway associated with the relays, the gateway configured for connection to an external network, the gateway being directly associated with at least one of the relays such that the gateway communicates with the relays via the directly associated relay, the gateway for providing communication between the external network and the relays.

2. The mesh network of claim 1, wherein each relay is configured to perform auto-configuration if newly added to the mesh network.

3. The mesh network of claim 2, wherein each gateway is configured to support the auto-configuration of newly added relays.

4. The mesh network of claim 1, wherein each gateway is configured to establish a routing architecture within the mesh cluster.

5. The mesh network of claim 1, wherein each relay is configured to perform load balancing with respect to traffic sent from the relay.

6. The mesh network of claim 1, wherein at least the relays are configured to support mobility of mobile nodes between the relays.

7. A method of configuring a relay newly added to a mesh network, comprising:
establishing an address from a zero-configuration address space;
selecting a gateway in the mesh network based on a gateway selection metric; and
communicating relay capabilities and the established address to the selected gateway.

8. The method of claim 7, wherein the gateway selection metric is one of a closest gateway and a least loaded gateway.

9. The method of claim 7, wherein the relay capabilities include at least one of a number of radio interfaces at the relay, neighbors visible to the relay in different frequency ranges, and observed interference.

10. The method of claim 7, further comprising:
receiving capabilities of the gateway.

11. The method of claim 10, wherein the gateway capabilities includes at least one of address for accessing the gateway, frequencies to use on relay and access interfaces, power levels to use for transmission, mobility management method to employ, addressing schemes, and path-specific information.

12. The method of claim 7, further comprising of authentication of the relay using an authentication scheme and backend AAA infrastructure

13. The method of claim 12, further comprising:
establishing a session key with the gateway as a part of the authentication.

14. The method of claim 13, where any Extensible Authentication Protocol (EAP) method capable of deriving a session key is used.

15. A method of establishing a routing architecture in a mesh network, comprising:
broadcasting a message to a network to obtain routing information on the network;
receiving the routing information regarding links in the network, the routing information indicating throughput through each link; and
establishing a routing architecture based on the received routing information.

16. The method of claim 15, wherein the broadcast message is a route request message with the destination-only flag set and a destination address set to broadcast.

17. The method of claim 15, wherein the routing information indicates an expected time to successfully transmit a packet on each link.

18. The method of claim 13, wherein the broadcasting step is performed periodically.

19. The method of claim 13, wherein the broadcasting step is performed by each gateway in the mesh network.

20. The method of claim 19, wherein the establishing step establishes a spanning tree rooted at the gateway as the routing architecture.

21. A method of supporting establishment of a routing architecture in a mesh network, comprising:
receiving a broadcasting message;
recognizing the broadcast message requests routing information;
generating the routing information regarding a link over which the broadcast message was received, the routing information indicating throughput through the link; and
sending the routing information in a response message.

22. The method of claim 21, wherein the broadcast message is a route request message with the destination-only flag set and a destination address set to broadcast.

23. The method of claim 21, wherein the routing information indicates an expected time to successfully transmit a packet on the link.

24. The method of claim 21, wherein, in the receiving step, the broadcast message is received at a relay.

25. A method of load balancing in a mesh network, comprising:
determining a least loaded gateway capable of handling communication; and
communicating with the least loaded gateway.

26. The method of claim 25, wherein the determining step is performed at a relay, and comprises:
determining a round trip time from the relay to each gateway operationally connected to the relay; and
selecting the gateway having a lowest round trip time as the least loaded gateway.

27. A method of load balancing in a mesh network, comprising:
switching from communicating with a first gateway to communicating with a second gateway if the second gateway is determined to be less loaded than the first gateway.

28. The method of claim 27, wherein the switching step only switches communicating with the first gateway to the second gateway for new data flows.

29. A method of managing mobility in a mesh network including gateways handling external communication for a plurality of relays, the relays handling communication with mobile nodes and communication between relays, the method comprising:
managing network address mapping in the mesh network such that only relay and gateway addresses are externally visible.

30. The method of claim 29, wherein the managing step establishes each gateway as an anchor node and establishes address mapping rules such that only relay and gateway addresses are externally visible.

31. A method of managing mobility in a mesh network including gateways handling external communication for a plurality of relays, the relays handling communication with mobile nodes and communication between relays, the method comprising:
managing network address mapping in the mesh network such that the mobile node addresses are not visible externally from the network.

32. The method of claim 31, wherein the managing step establishes each gateway as an anchor node and establishes address mapping rules such that the mobile node addresses are not visible externally from the network.

33. A method of managing mobility in a mesh network including gateways handling external communication for a plurality of relays, the relays handling communication with mobile nodes and communication between relays, the method comprising:
establishing a mobility agent at each relay and each gateway such that externally bound traffic from a mobile node is tunneled to the gateway and external in-bound traffic for a mobile node is routed without tunneling.

34. The method of claim 33, wherein the mobility agent in each relay monitors layer-2 association information to detect appearance of new visiting mobile nodes and departure of already associated mobile nodes.

35. The method of claim 33, wherein the mobility agents in different relays collaborate to manage routing tables at their respective relays
